(19) United States
(12) Patent Application Publication
(10) Pub. No.: US 2024/0347901 A1
(43) Pub. Date: Oct. 17, 2024

(54) Qc3 Healing Pyramid

(71) Applicant: Eric Staubes, San Diego, CA (US)

(72) Inventor: Eric Staubes, San Diego, CA (US)

(21) Appl. No.: 18/620,390

(22) Filed: Mar. 28, 2024

Related U.S. Application Data
(60) Provisional application No. 63/577,083, filed on Mar. 30, 2023.

(51) Int. Cl. H01Q 1/36; E04B 1/32

(52) U.S. Cl. CPC H01Q 1/36; E04B 1/3211

(57) ABSTRACT

The present invention is a healing pyramid that harnesses the intelligent energy that the fabric of space gives off. The intelligent energy of space is a new force that has been discovered and it is critical for humanity to start harnessing it. Collectively as a species, humans have been closed off to this healing energy and as a consequence we have to deal with degenerative diseases and global warming. The present invention will allow a user to see the benefits of using the energy of space to heal objects like gas and water. Once the benefits are acknowledged then the human spirit can begin to heal, and eventually, the earth will also be healed of global warming once a critical mass of humanity accepts this new discovery.

### RELATED APPLICATIONS

This application claims priority to U.S. Provisional Patent Application Ser. No. 63/577,083 for “QcCubed Space Energy Accumulator (S.E.A.),” filed Mar. 30, 2023, and currently co-pending, the entirety of which is incorporated herein by reference.

### FIELD OF THE INVENTION

The present invention pertains generally to a healing pyramid that channels the intelligent energy of space into an object placed in its interior to alter the composition to cause positive changes.

### BACKGROUND OF THE INVENTION

A common occurrence throughout history is that notable scientists often looked at problems the wrong way. For example, Aristotle believed that the Earth was really the center of the universe because of his own perspective. He observed the sun, moon, stars, and other planets revolving around the earth and assumed that was the correct science. However, Galileo disproved Aristotle's theory and showed that the sun was in fact the center of the universe. Despite making this groundbreaking discovery, Galileo argued that it was not possible for the moon to have an effect on the ocean's tides. This is likely because he failed to understand the full nature of the forces at work. In fact, it was not until the work done by Sir Isaac Newton, the father of classical mechanics, that it was mathematically proven that the moon does in fact impact the ocean's tides.

Following this thread of scientists looking at problems without a full understanding of the entire picture, we come to a discussion of the experiments carried out by notable physicists Albert Michelson and Edward Morey. The Michelson-Morely experiment was initially an attempt to measure the relative motion of Earth within the luminiferous ether. These experiments showed that there was no ether force, but really this is just another example of science looking at a problem incorrectly.

Both Michelson and Morely were incorrect in assuming that light would be affected by the ether. Instead, they should have viewed the ether as really the fabric of space and looked for the energy it gives off. This new energy is known as the energy of space, and it cannot directly be measured. However, what we do know is that the energy of space is real and that this energy connects directly to the earth. Unfortunately, over the years this connection has been disrupted and objects do not perform as well as they could.

To further understand this disruption, it is crucial to keep in mind the four fundamental forces that operate within the galaxy. These forces are gravity, the weak nuclear force, the strong nuclear force, and the electromagnetic force. When these forces are combined, they can only account for about a third of the force that is observed through the expanding universe. It is unclear what accounts for the remaining two thirds, some say that it is dark energy, but this does not offer any greater understanding.

Really what is happening is that the fabric of space is something that cannot be detected, but there are two sides and this fabric is what gives off this intelligent energy. On one side of the fabric, the side we currently reside in, there is everything that is created by light, while on the opposite side, there is nothing but light itself. That light travels through one side of the fabric of space and is what is driving the expansion of the universe, not the currently accepted Big Bang Theory. As the light travels through the fabric, it radiates the intelligent energy of space that has yet to be harnessed.

The Big Bang Theory is just another example of the flawed thinking that humans are currently engaged in. Unfortunately for us, this flawed thinking has entered into the collective consciousness that connects our species and has stunted our evolution. This state of stunted evolution has led to some serious consequences to both the individual and society as a whole. This flawed thinking affects individuals on a molecular level, and is the cause of degenerative diseases such as Parkinson's Disease. On a collective level, our flawed thinking alters how we perceive the earth, and the earth knows this because it is also intelligent. In response, the earth has begun to give off additional heat, and this heat is the true cause of global warming and not the greenhouse effect.

### SUMMARY OF THE INVENTION

The invention disclosed in this patent application is a healing pyramid that takes advantage of the energy of space. The Qc³ Healing Pyramid is able to channel this new energy to alter the composition of known materials. More specifically, the healing pyramid disclosed in this specification alters the composition of items placed in the interior of the pyramid so that beneficial changes take place. Further, this healing pyramid is not limited to only a few different areas, but instead has wide ranging applicability.

For example, in a non-limiting example gas that is placed inside the healing pyramid had its composition altered to ensure that it combusts much more efficiently, thus reducing automobile emissions. In another non-limiting example, a battery that was tested via traditional means, was no longer able to hold a charge. After spending multiple days inside the healing pyramid, the battery suddenly was able to hold a charge again due to the change in the properties of the battery.

To achieve these results, the healing pyramid works as an antenna to manifest the intent of both the user and the energy of space. Space is the source of all energy in space due to there being only one space throughout all of the universe for matter to occupy. Without a pyramid and a user that intends to harness this new energy, then the results of the pyramid will likely not be replicated.

The pyramid itself is of simple construction. It is an open-faced pyramid with four pieces of wood in the shape of a pyramid. At the top of the pyramid is an antenna, which takes the shape of a cross. The design of the antenna is crucial because it was designed so that it can receive the energy of space and channel that energy to the object placed directly below. Whatever is placed within the confines of the healing pyramid will be placed upon another wooden platform that is raised to a predetermined height.

The pyramid also has a number of different uses. The current embodiment is currently designed to alter the chemical composition of small objects such as water and gas. Using the healing pyramid at first for water and gas, it will demonstrate to individuals the benefit associated with accepting the intelligent energy of space and should be embraced. Once an individual accepts this idea, then not only will their flawed perception of the universe be changed but their belief system will change all the way down to the molecular level. With the belief system corrected, then any risk for degenerative disease, like Parkinson's Disease, will go away and the health of each individual will vastly improve.

As each individual learns to embrace the operation of the healing pyramid, then the collective thought process of the human species will begin to change. As the collective changes, then the soul of mother earth will see this shift in thought. Once that happens, our mother earth will stop emitting extra energy out into the atmosphere and instead it will project that energy to us humans. Then we will be able to continue our evolution as a species because our connection to the earth will be restored, and needlessly expelled energy will no longer cause global temperatures to increase.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a side view of a preferred embodiment of the Qc³ Healing Pyramid; and

FIG. 2 is a side view of an alternative embodiment of the Qc³ Healing Pyramid.

### DETAILED DESCRIPTION

Prior to the discussion about healing pyramid 100, the science of space needs to be further defined. Without the following explanation, then a proper understanding of the invention and its benefits cannot be understood.

The foundational theory that underpins the present invention is the discovery that space itself is actually intelligent. This is due to the simple fact that there is only one space occupying the entire universe. This implies that the space which contains the moving particles is the same as the space through which the planets move as they orbit about the Sun.

Additionally, while Einstein was correct about a number of different discoveries that led to the development of quantum mechanics, he incorrectly limited his foundational equation E=mc². It is certainly thrilling to imagine that the universe is composed of just energy, matter, and the speed of light; but, it was incredibly limited and shortsighted for Einstein to assume that our universe is really just a mechanical one. The discovery of the energy of space in 1979 led to the conclusion, that the universe is made up of intelligence, as well as energy, matter, and the speed of light.

To prove that space is in fact full of energy, the next series of equations need to outlined. First, it is known that the energy density of space is proportional to the frequency of the space cubed (v³). Second, it is also known the energy density of any given object is really just the energy store in the space per unit volume (E/V). Third, it is known that the speed of light, c, is equal to the wavelength, λ, times the frequency of a system, v; or c=λv. Fourth, the energy density of a particle is also known to be λ³, which allows us to rewrite the earlier mentioned equation, E/V, to be E/λ³. Fifth, it is to be assumed that frequency can be rewritten to equal v=c/λ, and due to that the frequency dependence of light is v³=c³/λ³ by simply raising each variable by a factor of three. Sixth, it is also to be assumed that Q is the intelligence constant, and this constant must be multiplied on both sides of the frequency dependence of light equation, leaving us with Qv³=Qc³/λ³. Seventh and most importantly, λ³ needs to be removed from the equation and that is achieved by the following equivalency: E/λ³=Qv³=Qc³/λ³. Once λ³ is canceled out from either side of the equation, then what you are left with is E=Qc³.

The aforementioned series of equations show that while Einstein was mostly right about things he wrote about, he incorrectly viewed the universe as a purely mechanical one. When intelligence, Q, is taken into account, the equation shifts and the energy of space can be both observed and taken advantage of.

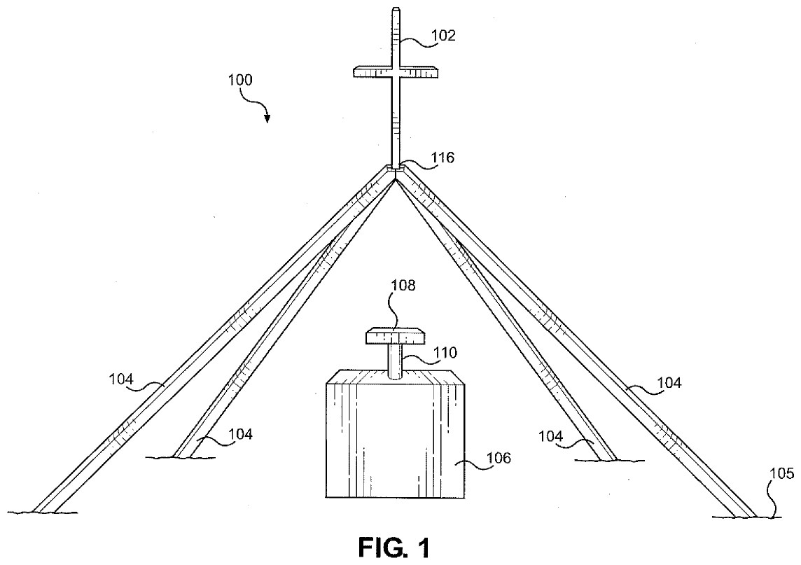

Referring now to FIG. 1, a top perspective view of healing pyramid 100 is shown. There are five main components of healing pyramid 100. Antenna 102, which takes the shape of a cross and is specifically tuned to the frequency of space energy. Antenna 102 is also attached to the healing pyramid at top 116 with rope ties and wood glue. As shown in FIG. 1, there are four different wood posts 104 that make up the different sides of healing pyramid 100. Each face of healing pyramid 100 will be open to the atmosphere, with platform assembly 106 located in the middle of the pyramid.

In a preferred embodiment each wood post 104 is cut at the bottom at a predetermined angle so that it can be placed atop ground 105. Additionally, healing pyramid 100 will work the best when installed on ground 105 that is level. Any obstructions that were located where each wood post 104 will rest will need to be removed. In this embodiment healing pyramid 100 is made out of wood, which provides the best results when using the device. While other materials can be used, such as PVC or Copper piping, the results have not been as positive. Further, regardless of the final size for any given healing pyramid 100, it is crucial that the final dimensions come out to 2b=πh, or twice the length of the base of healing pyramid 100 must equal the height times the transcendental number of pi.

Platform assembly 106 plays a critical role in the process that the present invention employs. There will be a riser 110 placed on the top surface of platform assembly 106. The height of riser 110 is a predetermined height so that platform 108 is positioned at a point within healing pyramid 100 so that maximum efficiency is achieved. A user will place any object they want on platform 108 and the space energy that is being harnessed by antenna 102 will be focused on that object.

The driving force behind this interaction is that antenna 102 operates similarly to a convex lens that is widely used today. If you take a convex lens and position it under the sun in a manner that concentrates the sun's energy onto a piece of paper, then that piece of paper will eventually catch on fire due to the increased heat. Here, antenna 102 magnifies the energy of space onto a specific area, thus magnifying its effects. Further, only beneficial effects take place, there is no drawback to concentrating the intelligent energy of space through the use of antenna 102. Everything will improve somehow when placed inside healing pyramid 100 thanks to the operation of antenna 102.

This can occur because platform 108 is positioned at the vortex of the pyramid. This allows healing pyramid 100 to take advantage of a fundamental principal of fluid mechanics, namely that fluid revolves around the axis line of said vortex. Antenna 102 will channel the space energy into the healing pyramid 100 such that the space energy revolves around the vortex located above platform 108 and will be directed into whatever object is placed atop platform 108.

Ideally, an object should be placed inside the confines of healing pyramid 100 for at least a period of 72 hours or more. While it appears that there is some kind of mechanical effect occurring with the objects placed inside the pyramid, what is really occurring is a transformation of nature due in part to antenna 102 harnessing the intelligent energy of space. So, with that in mind it can be safely assumed that there is an information exchange occurring between the object placed within healing pyramid 100 and the intelligent energy of space.

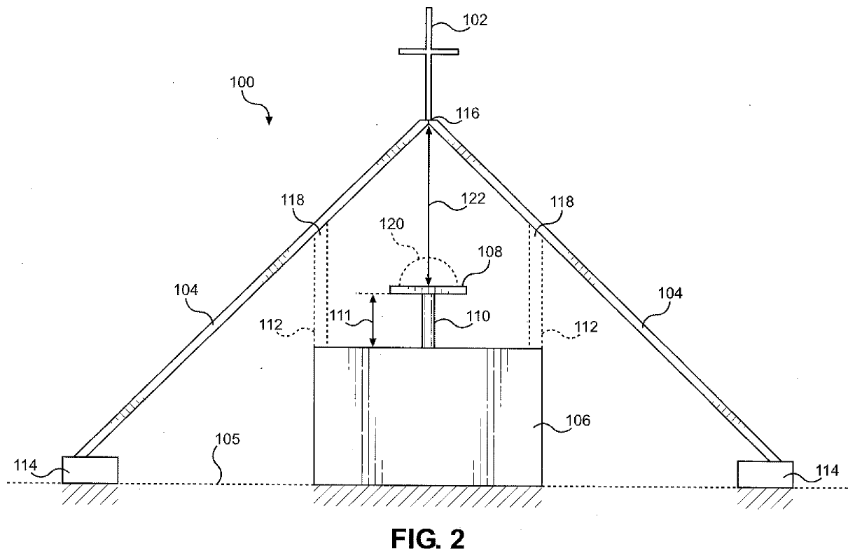

Referring now to FIG. 2, a side view of an alternative embodiment of healing pyramid 100 is shown. The biggest difference between this embodiment and the prior discussed one is the use of concrete block 114 to secure each wood post 104, and the optional use of vertical support 112 positioned at midpoint 118 of wood post 104. The incorporation of either of these two features will provide additional stability to healing pyramid 100 if the unit is installed in a windy or otherwise unstable area.

Also shown in this view is a more detailed view of of platform assembly 106 with riser 110 and platform 108 installed on top of it. Critically, there are two different bi-directional ranges shown. The first is adjustable range 111, which is an adjustable distance between the top of platform assembly 106 and the bottom of platform 108. The second is optimum distance 122, which is the distance between the top of platform 108 and the bottom of antenna 102. These two adjustable distances are variable to ensure that an object placed inside healing pyramid 100 is placed at the ideal location of 2h/3, which varies depending on the final dimensions of healing pyramid 100. This allows any individual to properly use healing pyramid 100, even if individual pyramids vary in size from one another.

As the space energy is channeled into the object placed atop platform assembly 106, it will begin to alter the composition of the object. Simultaneously with this energy transfer, the user of the pyramid must manifest an intent for healing changes to occur. In a non-limiting example, if a can of gas is placed atop platform assembly 106 and a user manifests intent for cleaner burning fuel, then the space energy will change the composition of the gas and allow it to burn cleaner.

The intent of the user is another critical component of healing pyramid 100. The energy of space functions for us in response to our belief in its capabilities; our expectation. Since we currently believe space is nothing, it acts towards us like it is nothing. However, healing pyramid 100 in conjunction with the intent of the user takes the energy of space and transforms the properties of an object placed inside healing pyramid 100.

Currently, I am one of the few people who possess the proper intent to operate healing pyramid 100. This is due namely to the masses accepting the flawed theories of science because that is what has been taught for generations. As each individual interacts with healing pyramid 100 then they will see the benefits of opening their mind to the possibility that space contains intelligent energy. With each person that learns to accept this truth, then slowly over time the collective mind of the human species will begin to alter.

There are a number of different benefits to this future shift in thinking. At an individual level, this change in thought will cure all degenerative diseases, namely Parkinson's Disease. This is because most people's misplaced faith in flawed science as altered their biochemistry down to the molecular level. As attitudes change, so will their biochemistry, which will prove to be a beneficial change in the long run. On a collective level, the human race will learn to accept the intelligent energy of space that is also in contact with the soul of the earth. As we embrace this intelligent energy, then our own connection with the soul of the earth will be restored, and the energy emitted by the earth will no longer cause global warming. Thus, healing pyramid 100 will not only give us the ability to cure Parkinson's Disease, but it will also halt global warming; ensuring the survival of our species for millennia to come.

I claim:

1. A healing pyramid comprising:
four posts, each having a top end and a bottom end, configured in the shape of a healing pyramid such that the bottom end of each post is spaced some distance apart from each other to form a square base, and the top ends are joined together to form a point of the healing pyramid;
an antenna in the shape of a cross that rests atop the point of the four posts;
a platform assembly placed within the pyramid at a middle point of the square base;
a platform that is placed atop the platform assembly and spaced some distance below the antenna, and
wherein any object placed inside the healing pyramid is placed on the platform.

2. The healing pyramid as in claim 2, wherein the antenna is tuned to the same frequency as the intelligent energy of space.

3. A healing pyramid as in claim 2, wherein the bottom of each post is spaced a distance such that twice the length of the square base is equal to pi times the height of the healing pyramid.

4. A healing pyramid as in claim 3, wherein the platform is located at distance below the antenna that is equal to twice the overall height of the healing pyramid divided by 3.

5. A healing pyramid as in claim 4, wherein the posts, platform assembly, platform and antenna are both made out of wood.

6. A healing pyramid as in claim 4, wherein the posts, platform assembly, platform, and antenna are constructed out of PVC.

7. A healing pyramid as in claim 4, wherein the posts, platform assembly, platform, and antenna are constructed out of copper piping.

8. A method for altering the composition of objects through the use of a healing pyramid comprising the steps of:
a user placing an object atop a platform located at the middle of the pyramid;
the user tuning an antenna placed atop the healing pyramid to match the frequency of the intelligent energy of space;
the user manifesting the intent for the intelligent energy of space to alter the composition of the object in a beneficial way; and
the user leaving the object within the pyramid for a period of at least seventy-two hours.

9. The method of claim 8, wherein the object placed within the pyramid is water.

10. The method of claim 9, wherein the object placed within the pyramid is gas.
